(19) United States
(12) Patent Application Publication
(10) Pub. No.: US 2026/0166589 A1
(43) Pub. Date: Jun. 18, 2026

(54) Screening Apparatus with Detachable Vibrating Screen

(71) Applicant: TYRONE INTERNATIONAL LIMITED, Coalisland (GB)

(72) Inventors: John MCCALL, Coalisland (GB); Padraig O'Neill, Coalisland (GB)

(21) Appl. No.: 19/294,245

(22) Filed: Aug. 7, 2025

(30) Foreign Application Priority Data
Dec. 12, 2024 (GB) 2418205.7

(51) Int. Cl. B07B 1/46; B07B 1/28

(52) U.S. Cl. CPC B07B 1/4609; B07B 1/28; B07B 2201/02

(57) ABSTRACT

A screening apparatus having a chassis, a vibrating screen, and a catch box. Detachable mounts attach the vibrating screen to the chassis. A frame engages the chassis that supports the vibrating screen and catch box. The frame can be raised out of and lowered into the chassis. Hydraulic rams or equivalent means move the frame between a lowered transport/access position, a raised mounting position, and a working position. The vibrating screen is mounted to the chassis with the detachable mounts and can rest on the frame when the mounts are detached. The vibrating screen is mounted to the chassis when the frame is in the working position or in the lowered position. The vibrating screen rests on the frame when the mounts are detached and the frame is in the lowered position or in the mounting position. The frame and catch box may be lowered independently from the vibrating screen.

### BACKGROUND OF THE INVENTION

### 1. Field of the invention

The present invention relates to improvements in screening apparatus, e.g., for wash plants and the like, in particular to screening apparatus that include a vibrating screen that may be detached without the need for heavy machinery such as cranes.

### 2. Prior Art Description

Vibrating screens are available in both tracked mobile and static units. Screening apparatus comprising a vibrating screen is generally employed for a wide range of materials including sand, gravel, topsoil, crushed stone, construction, and demolition waste, mine ore, blasted rock and river gravel, for example to dewater sand and to remove or separate dust, dirt, silt and fines from aggregate materials like sand, sizing the aggregates.

Typically, high frequency vibrating screens operate at an inclined angle optimized to reduce moisture of materials. In order to dewater a material effectively, the material is fed on to a steep, upward inclined screen surface at the feed end and subject to counter-rotating vibratory motors aligned at an angle to the screen surface such that the abrupt reversal of motion detaches water from the material and the water droplets pass through the screen media into a catch box, with the solids being conveyed up the screen by linear motion.

In conventional screens, the screen comprises metal or polyurethane mesh or perforated metal sheet fastened to a support frame at their side edges, i.e. at the longitudinal edges thereof parallel to the forward moving direction of the materials to be handled. The robust screen frame is typically manufactured in either a welded or a bolted design. The frame is both bulky and heavy. Thus, if work is required on a screen or the catch box beneath the screen, a crane is required to lift the frame and the vibrating screen within the frame out of the chassis. The frame is lowered to the ground, wherein the vibrating screen and catch box can be disassembled and the various parts repaired and/or replaced.

Patent Reference WO 2022/194,787 and U.K. Patent No 2,606,584 both show screening machines in which a vibrating screen and catch box slidably engage with a chassis between a lowered transport position and a raised working position. However, to have full access to the prior art vibrating screen and catch box for maintenance, the vibrating screen, the catch box and the inner support frame holding the vibrating screen and the catch box must be removed from the chassis and disassembled.

A need therefore exists for a screening apparatus with a frame that supports a vibrating screen and catch box, wherein the screening apparatus is configured to provide access to the vibrating screen and catch box without the need to remove the frame from the chassis. This need is met by the present invention as described and claimed below.

### SUMMARY OF THE INVENTION

The present invention relates to screening apparatus with a catch box and frame which may be raised and lowered together with a vibrating screen or independently from the vibrating screen without the need for heavy machinery such as a crane. The screening apparatus has a chassis with a top flange. The chassis supports a vibrating screen and a catch box that is located under the vibrating screen. Detachable mounts are provided for removably mounting the vibrating screen to the chassis.

The catch box is located underneath the vibrating screen. A frame is provided that is configured to slidably engage with the chassis. The frame can accept and support the vibrating screen and catch box. The frame is capable of being raised out of and lowered into the chassis.

Frame pins are provided that can be inserted into the chassis. Hydraulic rams or equivalent means are provided to raise and lower the frame relative to the chassis. The frame can be moved between a lowered position for transport and access, a raised mounting position, and an intermediate working position. The vibrating screen is configured to be mounted to the chassis with the detachable mounts. When the detachable mounts are detached, the vibrating screen rests on the frame.

The vibrating screen is mounted to the top flange of the chassis with the detachable mounts when the frame is in the working position and when the frame is in the lowered position for access. The vibrating screen rests on the frame when the detachable mounts are detached and the frame is either in the lowered position for transport or in the mounting position. When the vibrating screen is mounted to the top flange of the chassis, the frame and catch box can be lowered independently from the vibrating screen. This provides access both to the vibrating screen and to the catch box for repairs and maintenance without having to remove the frame from the chassis.

### BRIEF DESCRIPTION OF THE DRAWINGS

Certain preferred embodiments of the present invention will now be described, by way of example only, with reference to the accompanying drawings in which:

FIG. 1 is a perspective view of a preferred screening apparatus in transport mode according to the invention;

FIG. 2 is an exploded perspective view of the detachable screen, frame and catch box of the screening apparatus of FIG. 1;

FIG. 3 is a perspective view of the detachable screen, frame and catch box of FIG. 2;

FIG. 4 is a perspective view of the screening apparatus of FIG. 1 with the detachable screen, frame and catch box raised in the mounting position, showing where mounting brackets are to be added;

FIG. 5 is a cutaway view of FIG. 4 with the guide channels and the connection of hydraulic rams to the chassis visible and showing mounting brackets in place;

FIG. 6 is a perspective view of the screening apparatus of FIG. 1 with the detachable screen, frame and catch box raised in the mounting position, showing where frame pins may be inserted to secure the apparatus in the working position;

FIG. 7 is a perspective view of the screening apparatus of FIG. 1 in the working position;

FIG. 8 is a perspective view from below of the screening apparatus of FIG. 1 in the working position;

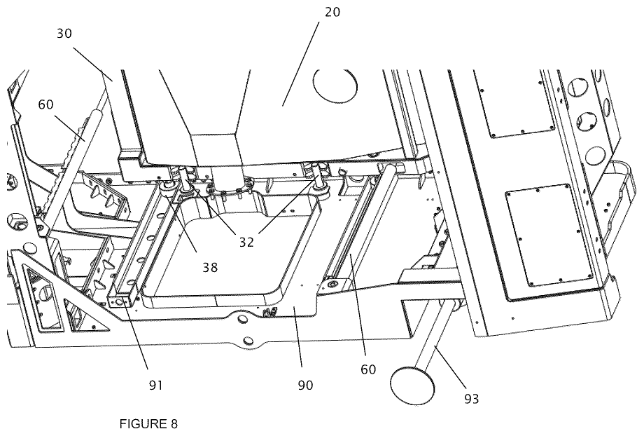

FIG. 9 is a perspective view of the screening apparatus of FIG. 1 with the screen in the raised working position and the frame and catch box in the lowered access position; and

FIG. 10 is a cutaway view of FIG. 9.

### DETAILED DESCRIPTION OF THE DRAWINGS

Although the present invention system can be embodied in many ways, only one exemplary embodiment is illustrated and described. The exemplary embodiment is selected in order to set forth one of the best modes contemplated for the invention, The illustrated embodiment, however, is merely exemplary and should not be considered a limitation when interpreting the scope of the appended claims.

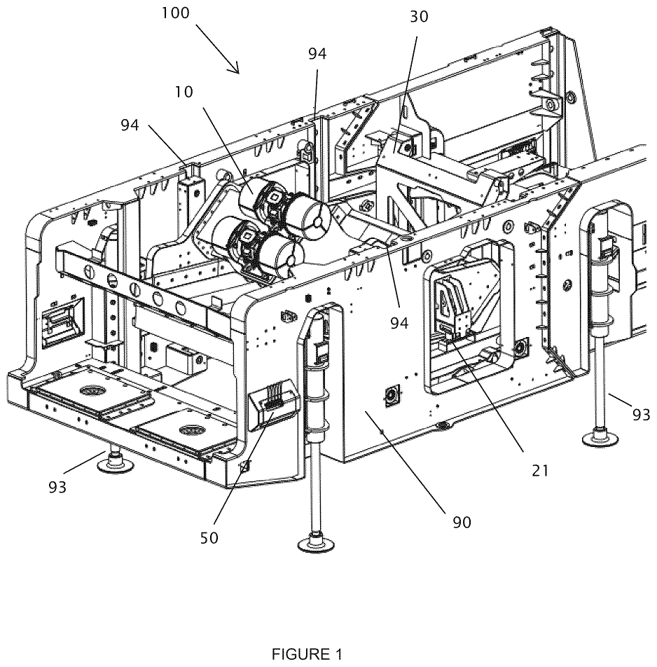

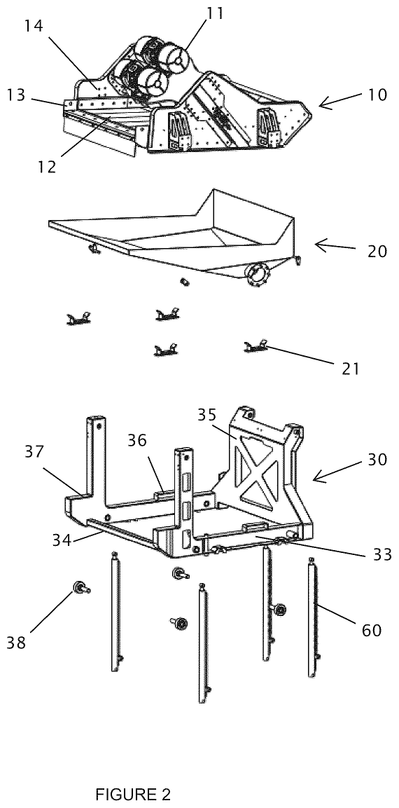

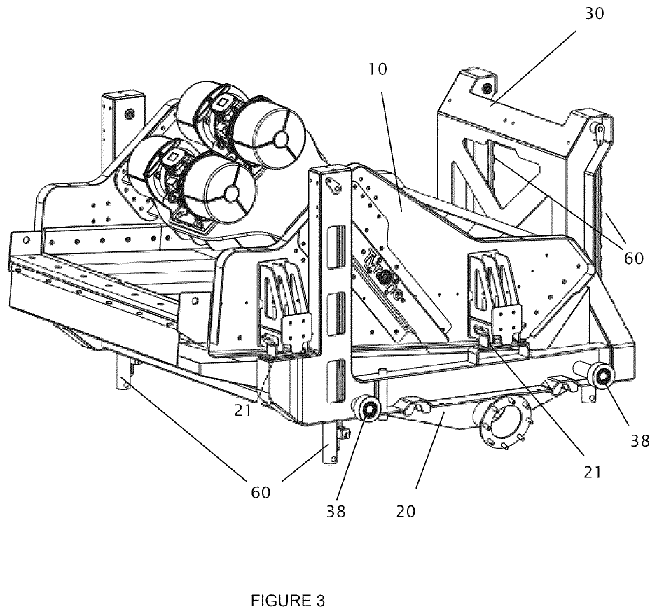

Referring to FIG. 1, a screening apparatus 100 is shown having a chassis 90 that supports a vibrating screen 10. Referring to FIG. 2 and FIG. 3 in conjunction with FIG. 1, it can be seen that the vibrating screen 10 is used for separating material. A catch box 20 is positioned under the vibrating screen 10 to catch screened material. The catch box 20 is supported by a frame 30 beneath the vibrating screen 10. As shown in FIG. 3, vibrating screen 10 may rest on frame 30. However, as will be explained, the vibrating screen 10 can be selectively detached from the frame 30 and rested upon the chassis 90 while the frame 30 is lowered in the chassis 90. This enables access to each of the vibrating screen 10 and catch box 20 for any one or more of maintenance, replacement and repair.

The vibrating screen 10 may be any motorized vibrating screen 10 such as a linear motion screen, a circular motion screen, or an elliptical motion screen. The vibrating screen 10 has a drive 11 that induces vibration. The vibration is transferred to a screen media 12 that causes particle separation. A deck 13 is utilized to transmit the vibration and support both the screen media 12 and the drive 11. The deck 13 rests in an open top box frame 14. The screen media 12 in the vibrating screen 10 preferably comprises ISEPREN WS 85 modular panels or other such modular panels manufactured from polyurethanes with a highly resilient wear-resistant surface supported by a high strength structural polyurethane containing load carrying reinforcement.

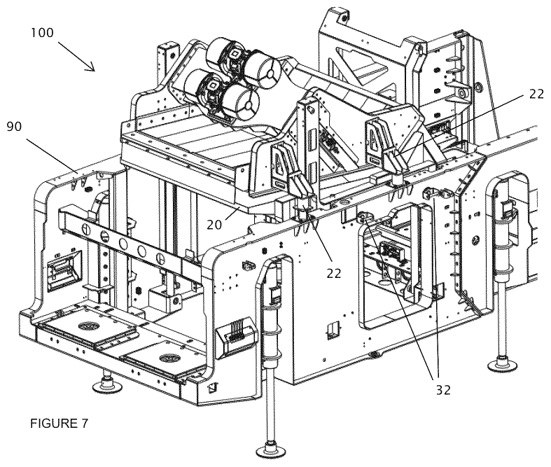

When screening apparatus 100 is in the transport position as shown in FIG. 1, the vibrating screen 10 rests on frame 30 in screen support brackets 21. Rather than being welded, screen support brackets 21 are bolted or otherwise fastened to frame 30 to allow for their removal in the working position of screening apparatus 100 as shown in FIG. 7, i.e., during use of vibrating screen 10 to separate material.

The catch box 20 is located beneath the vibrating screen 10 to receive the material that passes through the screen media 12. The material being screened is an aggregate of material and water. Conduits and pumps (not shown) may be provided to remove the aggregate material/water mix from catch box 20.

In the preferred embodiment, frame 30 has two parallel L-shaped sides 33 that are connected by transverse member 34 at the corners and by an upright back 35 at the other end. The L-shaped side members 33, transverse member 34, and upright back 35 surround an open base.

The screening apparatus 100 uses the chassis 90 for supporting frame 30 and other components as required. The chassis 90 may take any suitable conventional form, typically being configured to support the screening apparatus 100 above ground level to provide space beneath the screening apparatus 100 for tracks.

In the exemplary embodiment shown, four stabilizing jack legs 93 are used to support the screening apparatus 100 above ground level. However, this is not to be considered limiting and other methods of support, e.g., fixing stools bolted to the chassis and the ground, may be contemplated within the scope of the invention.

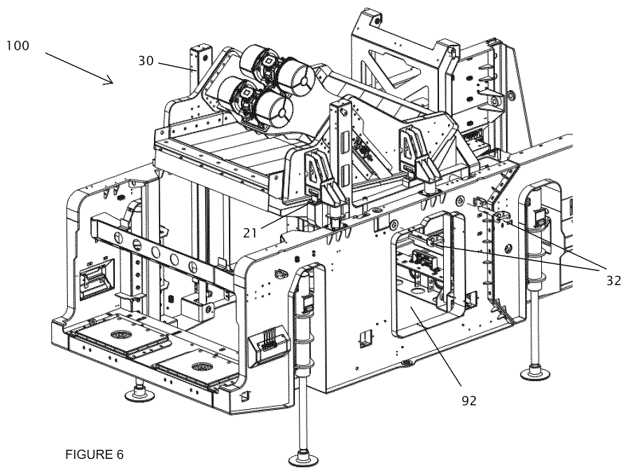

The frame 30 is slidably mounted to chassis 90 via rollers 38. The rollers 38 travel in guide channels 91. As further described herein below, screening apparatus 100 may be fixed in a first position for transport (see FIG. 1) apparatus 100 and can be moved to a second position directly above the first position in which the vibrating screen 10 and catch box 20 are lifted out of the chassis (see FIG. 6). The second position enables mounting of the vibrating screen 10 to a top flange 95 of the chassis 90. Screening apparatus 100 can be moved to a third position for working, intermediate the first and second positions (FIG. 7).

Four hydraulic rams 60 are connected to the frame 30 from the chassis 90 for vertically raising and lowering the frame 30 relative to chassis 90 between the three positions. Four guide channels are provided in the frame 30 for accepting the hydraulic rams 60. Two of the guide channels are located in upright back 35 and one guide channel is located in each L-shaped side member 33. As shown in the figures, the rams 60 allow frame 30 to move up or down, with or without the vibrating screen 10. However, this is not to be considered limiting and other lifting means may be contemplated within the scope of the invention.

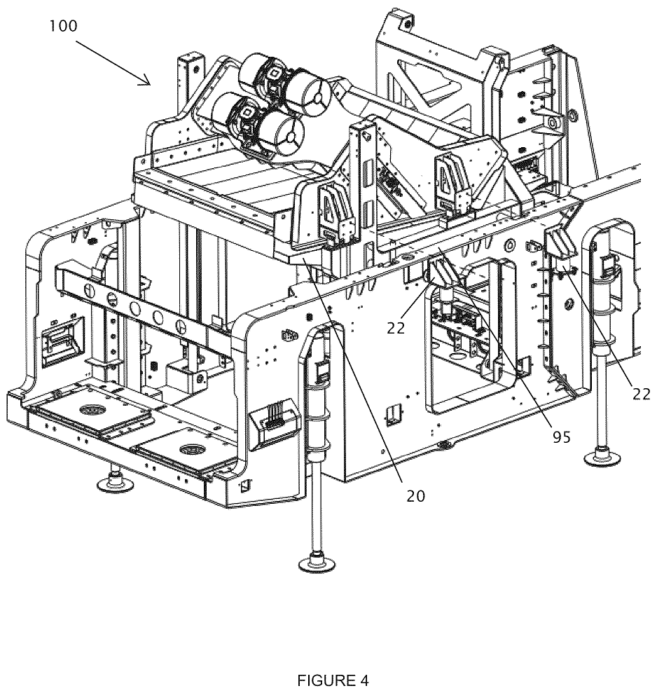

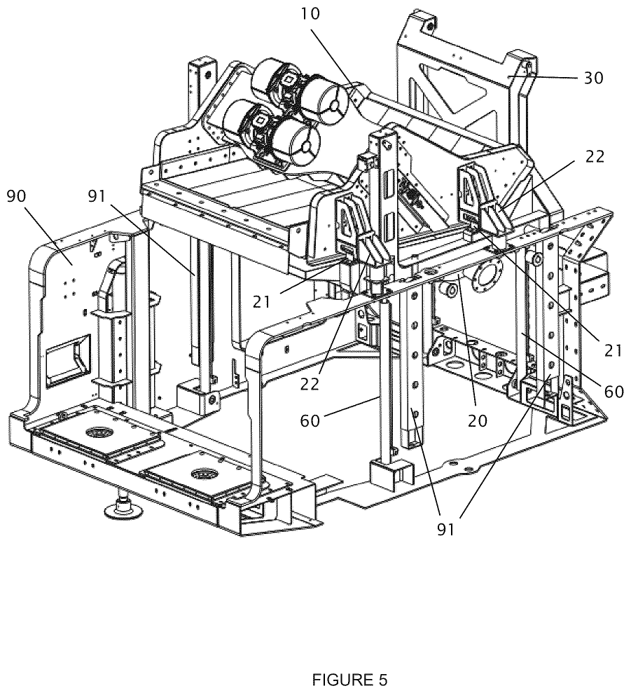

A hydraulic control bank 50 is located on chassis 90 to control rams 60. When the hydraulic rams 60 are fully extended, they lift the frame 30 with the catch box 20 and the vibrating screen 10 up above the top of chassis 90 in the mounting position. Substantially L-shaped screen mounting brackets 22 are attached onto screen 10 and the top surface flange 95 of the chassis 90 as shown in FIGS. 4 to 6.

Once detachable screen mounting brackets 22 are attached to vibrating screen 10 and the flange 95, frame pins 32 are inserted under frame 30 from the side of chassis 90, as shown in FIG. 6. The frame 30 with catch box 20 may then be lowered onto the frame pins 32 using the control bank 50. As such, the frame 30 with catch box 20 is hydraulically held in working position as shown in FIG. 7. The vibrating screen 10 is now independent from both the frame 30 and the catch box 20. The screen support brackets 21 are removed from the frame 30 to provide clearance under mounting brackets 22 to avoid damage to frame 30 from vibrations. Vibrating screen 10 is well supported as the forces are acting vertically down on the flange 95.

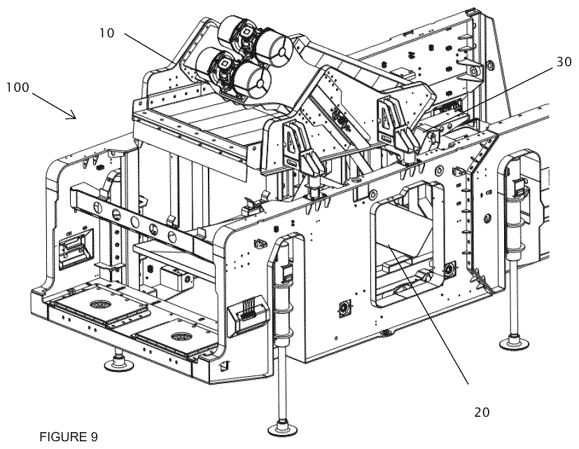

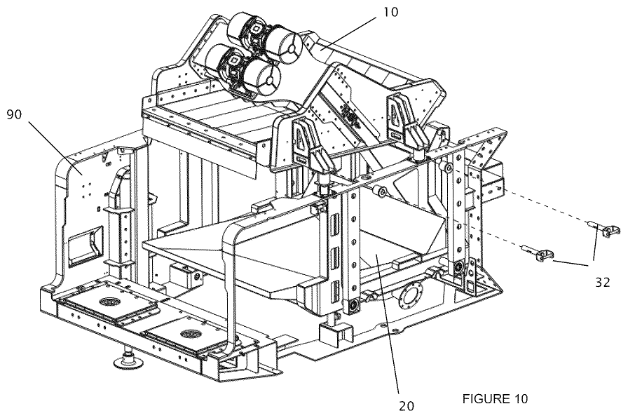

Referring to FIG. 9 and FIG. 10 in conjunction with the prior figures, it can be seen that after removal of the frame pins 32, the frame 30 and the catch box 20 may be lowered to the access position independently from the vibrating screen 10 to allow full access to the inside of the catch box 20 and the underside of the screen 10, e. g., for maintenance inspections and repairs. The chassis 90 is provided with window 92 to provide quick and easy access to the lowered catch box 20 when the vibrating screen 10 is mounted on the flange 95.

In the present invention, the prior described process is reversed to transport the vibrating screen 10 back down into the chassis 90. Firstly, the screen support brackets 21 are replaced and the rams 60 are fully extended with the screen mounting brackets 22 mounted on the frame 30. Once frame 30 and catch box 20 are raised into the mounting position, frame pins 32 are removed and the screen mounting brackets 22 are detached from the vibrating screen 10 and the chassis 90 such that the vibrating screen 10 fully rests on the support brackets 21 on frame 30. The vibrating screen 10 can be lowered into chassis 90 with catch box 20 for transport.

It will therefore be understood that the vibrating screen 10 and catch box 20 can be accessed for maintenance without the need for removal using heavy machinery such as cranes. This is made possible by providing a frame 30 for supporting the vibrating screen 10 and catch box 20, wherein the frame 30 is configured to lower the catch box 20 separately from the vibrating screen 10 whilst the vibrating screen 10 remains supported to allow a person, such as a welder, to stand up inside the chassis 90. The frame 30 is further configured to raise and lower the vibrating screen 10 and catch box 20 together for transport purposes. This is a great improvement over prior art systems where work on a screen or a catch box would require a crane to lift these components out of the chassis and place on the ground to be disassembled.

Additionally, the frame 30, vibrating screen 10 and catch box 20 may be raised by the lift for raising and lowering said frame 30 to allow the mounting of the vibrating screen 10 to the chassis 90 for use in the working position using the detachable mounts, which mounting may be performed by a single person.

Advantageously, the frame 30 and catch box 20 may be lowered independently from the detachable vibrating screen 10 once the vibrating screen 10 is mounted to the chassis 90, allowing for improved maintenance access and inspection access compared to known wash plant screens. Thus, the screening apparatus 100 permits the catch box 20 to be raised and lowered together with the vibrating screen 10 or independently from the vibrating screen 10.

In some embodiments, frame 30, and with it the detachable vibrating screen 10 and catch box 20, is lowered into and raised above the chassis 90 vertically. This enables a machine incorporating the screening apparatus 100 according to the invention to comply with legal transport dimensions. However, this is not to be considered limiting and the frame 30, and with it the detachable vibrating screen 10 and catch box 20, may alternatively be lowered into and raised above the chassis 90 diagonally.

Frame 30 of the screening apparatus 100 is so constructed that it can be fitted on either a static or a mobile wash plant, e.g., wherein the chassis 90 is the support structure of a static wash plant rather than a mobile chassis with tracks. The frame 30 preferably comprises a square or rectangular open base and one or more guide channels protruding upwardly from the base to accept the lift for raising and lowering the frame 30.

As previously described, frame 30 may be fixed in a first position for transport. In the first position, the frame 30, catch box 20 and vibrating screen 10 are lowered into the chassis 90. The frame 30 can also be fixed in a second position that is directly above the first position. In the second position, vibrating screen 10 and catch box 20 are lifted out of the chassis 90 to allow mounting of the vibrating screen 10 to the chassis 90. The frame 30 can also be fixed to a third position that is intermediate to the first position and the second position when the screening apparatus 100 is in its working mode. In the third position, frame 30 is configured to rest on removable frame pins 32 inserted into the chassis 90 when the screening apparatus 100 is in the working position.

When the frame 30 is fixed in the first position, the screening apparatus 100 may be in one of two positions. The two positions include a transport position as described above or in an alternate, an access position. In the access position, only frame 30 and catch box 20 are lowered into the chassis 90 with vibration screen 10 remaining mounted to the top flange.

When the screening apparatus 100 is in the transport position, the detachable vibrating screen 10 rests on frame 30, preferably in the screen support brackets 21. This is particularly preferable wherein the screen support brackets 21 are bolted or otherwise removably fixed to frame 30 to allow for their removal in the working position of the screening apparatus 100, i.e., during use of vibrating screen 10 to separate material.

Once the screening apparatus 100 is in the mounting position, the vibrating screen 10 may be attached to the top flange 95 of the chassis 90, and the frame 30 and catch box 20 together may be lowered into the access position. The difference between the screening apparatus 100 being in the access position and the transport position is that in the access position, the vibrating screen 10 is raised and mounted to the chassis 90 with the frame 30 and catch box 20 lowered. In the transport position, all three components are lowered into the chassis 90 as the frame 30 is not fixed to the chassis 90. In other words, frame 30 and catch box 20 are in the same location for both the transport and access positions of the screening apparatus 100.

The chassis 90 of the screening apparatus 100 is for supporting the frame 30 and other components as required, e.g., part of the lift for raising and lowering the frame 30. The chassis 90 may take any suitable conventional form, typically being configured to support the screening apparatus 100 above ground level to provide space beneath screening apparatus 100, for example for tracks or other components. Furthermore, the screening apparatus 100 is provided with stabilizing jack legs 93 to support the chassis 90 above ground level.

In a preferred embodiment, the detachable mounts are anti-vibration mounts and are used to stop vibrations travelling from vibrating screen 10 to the chassis 90 during use and to avoid structural damage such vibrations would otherwise cause. Preferably, the mounts are each independently substantially L-shaped and comprise one or more annular springs, particularly preferably wherein the annular springs are made of rubber or from a combination of rubber and fabric. However, this is not considered to be limiting and the detachable mounts may comprise alternative anti-vibration devices such as Rosta oscillating mountings. In a preferred embodiment, the screening apparatus 100 is provided with four detachable mounts, two on either side of the vibrating screen 10.

The vibrating screen 10 of the screening apparatus 100 may comprise single or multiple decks using a range of screen media with multiple apertures. In some embodiments, the screening angle may be adjustable to suit the material being processed.

In some embodiments, the lift for raising and lowering the frame 30 relative to the chassis 90 comprises at least one lift unit which moves the frame 30 from the transport position upwards to the mounting position and from the mounting position downwards to the transport position via the working position, preferably wherein the lift unit moves the frame 30 vertically. The lift unit is particularly preferably a powered lift unit. Each lift unit may independently comprise a hydraulic lift unit. However, this is not to be considered limiting and other means of effecting movement such as an electric actuator, mechanical jack, etc. may be used in addition to or instead of a hydraulic lift unit. The hydraulic lift units may comprise hydraulic control banks having levers that operate hydraulic cylinders in connection with the frame 30 to raise or retract the frame 30 together with the catch box 20 and with or without the vibrating screen 10 of the apparatus 100.

The lift for raising and lowering the frame 30 comprises one or more hydraulic control banks. Each control bank 50 includes multiple hydraulic rams 60 connected to the frame 30. Preferably, there are two hydraulic control banks 50 and four hydraulic rams 60 for raising and lowering the frame 30.

Frame 30 is configured to slidably engage with the chassis 90, preferably wherein one or more guide channels 91 run along the inside of the chassis 90. The guide channels 91 preferably run vertically along the inside of the chassis 90 for facilitating the sliding of the frame 30 and catch box 20 with or without the vibrating screen 10.

Frame 30 is preferably slidably mounted to the chassis 90 via rollers 38 in guide channels 91 on the chassis 90. It is preferred that frame 30 is provided with an even number of guide rollers 38 and the chassis 90 with the same number of guide channels 91. Alternatively, instead of rollers, plastic low friction material such as ultra-high molecular weight polyethylene can be provided on the exterior of the frame 30 for slidable engagement in the guide channels 91, for example in a thickness in the range of about 10 mm. Preferably, there are four vertical guide channels 91, two each side of the chassis 90. However, this is not to be considered limiting and more or fewer guide channels may be present.

Additionally, there are a plurality, e.g., four, frame pins 32 located at multiple, e.g., four, locations on the chassis 90 for securing the frame 30, and with it the vibrating screen 10 and catch box 20, in the working position. However, this is not to be considered limiting and more or fewer frame pins 32 may be present on the screening apparatus 100.

In another aspect, the invention provides a mobile wash plant comprising a screening apparatus as described herein, wherein the chassis is tracked.

In yet another aspect of the invention, a method for converting the screening apparatus 100 as described herein into the access position is provided for enabling access to the underside of the vibrating screen 10 and inside of the catch box 20, whereby the vibrating screen 10 may be raised with the catch box 20 and the catch box 20 lowered without the vibrating screen 10. The method includes activating the lift for raising and lowering the frame 30 to lift the frame 30, catch box 20 and vibrating screen 10 up above the top of the chassis 90 into the mounting position, if the screening apparatus 100 is not already in the mounting position. The detachable mounts are attached to vibrating screen 10 and to chassis 90. The frame pins 32 for holding the frame 30 in the working position are removed from the chassis 90. Lastly, the lift for raising and lowering the frame 30 is activated to lower the frame 30 with the catch box 20 into the access position.

To convert the screening apparatus 100 from the access position into the working position, the lift for raising and lowering the frame 30 is activated to raise the frame 30 and catch box 20 into the working position. Frame pins 32 may be inserted into the chassis 90 for the frame 30 to rest on so the frame 30 cannot be lowered into the chassis 90.

To convert the screening apparatus 100 from the access position into the transport position, the lift for raising and lowering the frame 30 is activated to raise the frame 30 and catch box 20 into the mounting position. The detachable mounts are detached from vibrating screen 10 and chassis 90 such that the vibrating screen 10 then fully rests on the frame 30 and can be lowered into the chassis 90 with the catch box 20 for transport.

The skilled person will understand that where the same feature has been referenced in different aspects of the invention, this feature comprises the same parts and operates in the same way unless otherwise stated. It is also to be understood that the invention is not limited to the specific details described herein which are given by way of example only and that various modifications and additions are possible without departing from the scope of the invention as defined in the appended claims.

What is claimed is:

1. A screening apparatus comprising:
a chassis having a top flange;
a frame configured to slidably engage with the chassis wherein the frame is capable of being moved within said chassis;
a lift for raising and lowering the frame relative to the chassis, wherein the frame can be moved between a lowered position for transport and access, a raised mounting position, and an intermediate working position;
a vibrating screen;
detachable mounts for selectively attaching the vibrating screen to, and detaching the vibrating screen from, the chassis;
a catch box located underneath the vibrating screen;
frame pins that insert into the chassis;
wherein the vibrating screen is mounted to the top flange of the chassis with the detachable mounts when the frame is either in the working position or in the lowered position for access, therein enabling said frame and said catch box to be lowered by the lift within said chassis without said vibrating screen, and
wherein the vibrating screen rests on the frame when the detachable mounts are detached and the frame is in the lowered position for transport and when the detachable mounts are detached and the frame is in the mounting position.

2. The screening apparatus as claimed in claim 1, wherein the chassis is provided with a guide channel and the frame is provided with a roller to engage with the guide channel.

3. The screening apparatus as claimed in claim 1, wherein the frame is provided with an even number of guide rollers and the chassis is provided with guide channels equal to the even number of guide rollers.

4. The screening apparatus as claimed in claim 1, wherein the chassis is provided with a guide channel running along an inside surface thereof and the frame has an external surface provided with low friction plastic material for slidable engagement in the guide channel.

5. The screening apparatus as claimed in claim 1, wherein the frame is adapted to be raised out of and lowered into the chassis vertically.

6. The screening apparatus as claimed in claim 5, wherein the chassis is provided with a guide channel running vertically and the frame is provided with a roller to engage with the guide channel.

7. The screening apparatus as claimed in claim 1, wherein the lift for raising and lowering said frame relative to the chassis comprises a plurality of hydraulic lift units which move the frame from the lowered position upwards to the mounting position and from the mounting position downwards to the lowered position via the working position.

8. The screening apparatus as claimed in claim 1, wherein the chassis is tracked.

9. A wash plant comprising a screening apparatus as claimed in claim 1.

10. A mobile wash plant comprising a screening apparatus as claimed in claim 8.

11. A method for enabling access to an underside of the vibrating screen and an inside of the catch box of the screening apparatus claimed in claim 1, said method comprising the steps of:
a) activating the lift for raising and lowering the frame to lift the frame, the catch box, and the vibrating screen up above the top flange of the chassis into the mounting position, provided the screening apparatus is not already in the mounting position;
b) ensuring the detachable mounts are attached to the vibrating screen and to the chassis;
c) ensuring the frame pins for holding the frame in the working position are removed from the chassis; and
d) activating the lift for raising and lowering the frame to lower the frame with the catch box into the lowered position for access.
